(19) United States
(12) Patent Application Publication
(10) Pub. No.: US 2016/0067641 A1
(43) Pub. Date: Mar. 10, 2016

(54) HOT OIL DURABLE MEDIA

(71) Applicant: Hollingsworth & Vose Company, East Walpole, MA (US)

(72) Inventor: Augusto Rodriguez, Grayson, GA (US)

(73) Assignee: Hollingsworth & Vose Company, East Walpole, MA (US)

(21) Appl. No.: 14/479,900

(22) Filed: Sep. 8, 2014

(51) Int. Cl. B01D 39/16; B01D 29/00

(52) U.S. Cl. CPC B01D 39/1623; B01D 29/0093

(57) ABSTRACT

Fiber webs that include an acid scavenger are provided. In certain embodiments, the acid scavenger may be immobilized within a resin and/or on the fiber web. In some embodiments, such fiber webs are used in filter media. The filter media may be suitable for filtering fluids that contain one or more acids. The acid scavenger may serve to complex and/or neutralize acids in the vicinity of the fiber web, thereby rending the fiber web more durable against degradation in acidic environments. The respective characteristics and amounts of the acid scavenger on the fiber web may be selected to impart desirable properties to the fiber web, including enhanced mechanical and performance properties (e.g., relatively high strength and lifetime) during filtration. Filter media formed of the fiber webs may be particularly well-suited for applications that involve filtering lubricating oil or hydraulic fluids, though the media may also be used in other applications.

### FIELD OF INVENTION

The present embodiments relate generally to fiber webs, and specifically, to fiber webs that can be used as filter media for filtering hot oil.

### BACKGROUND

Filter media can be used to remove contamination in a variety of applications. In general, filter media include one or more fiber webs. The fiber web provides a porous structure that permits fluid (e.g., fuel, lube, hydraulic fluid, air) to flow through the web. Contaminant particles contained within the fluid may be trapped on the fiber web. Fiber web characteristics (e.g., additives, fiber dimensions, fiber composition, basis weight, amongst others) affect mechanical properties and filtration performance of the media.

In some applications, fiber webs may be used as filter media for lubricating fluids at elevated temperatures, which may be acidic. Although many types of fiber webs exist, fiber webs that are durable in heated lubricating fluid and/or resistant to degradation in acidic environments would be beneficial. Improvements in the physical and/or performance characteristics of the fiber web (e.g., lifetime, strength, permeability, efficiency, dust holding capacity) in such environments would also be beneficial.

### SUMMARY

In one set of embodiments, fiber webs are provided. In one embodiment, the fiber web comprises a plurality of cellulose fibers having an average fiber diameter between about 2 microns and about 75 microns and an average length between about 1 mm and about 15 mm, a resin comprising a non-particulate acid scavenger, and 0-30 wt. % synthetic fibers.

In another embodiment, the fiber web comprises a plurality of cellulose fibers having an average fiber diameter between about 2 microns and about 75 microns and an average length between about 1 mm and about 15 mm, 0-30 wt. % synthetic fibers, and an acid scavenger, wherein the fiber web has a dry Mullen burst strength of greater than or equal to about 12 psi after being immersed in 150° C. synthetic oil for at least 168 hours.

In another set of embodiments, methods of filtering a liquid are provided. In one embodiment, the method comprises passing a liquid across a fiber web, wherein the fiber web comprises a plurality of cellulose fibers having an average fiber diameter between about 2 microns and about 75 microns and an average length between about 1 mm and about 15 mm, a resin comprising a non-particulate acid scavenger, and 0-30 wt. % synthetic fibers.

In another embodiment, the method comprises passing a liquid across a fiber web, wherein the fiber web comprises a plurality of cellulose fibers having an average fiber diameter between about 2 microns and about 75 microns and an average length between about 1 mm and about 15 mm, 0-30 wt. % synthetic fibers, and an acid scavenger, wherein the fiber web has a dry Mullen burst strength of greater than or equal to about 12 psi after being immersed in 150° C. synthetic oil for at least 168 hours.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figure, which is schematic and is not intended to be drawn to scale. In the figure, each identical or nearly identical component illustrated is typically represented by a single numeral. For purposes of clarity, not every component is labeled, nor is every component of each embodiment of the invention shown where illustration is not necessary to allow those of ordinary skill in the art to understand the invention. In the figures:

FIG. 1A is a schematic diagram showing a cross section of a fiber web including a plurality of fibers according to one set of embodiments;

FIG. 1B is a schematic diagram showing a cross section of a fiber web including fibers that are partially coated with a resin including an acid scavenger according to one set of embodiments;

FIG. 1C is a schematic diagram showing a cross section of a fiber web in which substantially all of the fibers are coated with a resin including an acid scavenger according to one set of embodiments.

### DETAILED DESCRIPTION

Fiber webs that include an acid scavenger are provided. In certain embodiments, the acid scavenger may be immobilized within the resin and/or on the fiber web. For example, the fiber web may be coated with a resin comprising the acid scavenger. In some embodiments, such fiber webs are used in filter media. The filter media may be suitable for filtering fluids that contain one or more acids. The acid scavenger may serve to complex and/or neutralize acids in the vicinity of the fiber web, thereby rending the fiber web more resistant to degradation in acidic environments. The respective characteristics and amounts of the acid scavenger on the fiber web may be selected to impart desirable properties to the fiber web, including enhanced mechanical and performance properties (e.g., relatively high strength and lifetime) during filtration. Filter media formed of the fiber webs may be particularly well-suited for applications that involve filtering hydraulic fluids or lubricating oil, though the media may also be used in other applications (e.g., for filtering air).

A fiber web described herein may be used to filter a fluid comprising a species, such as an acid, that adversely interacts with at least one component of the fiber web (e.g., the fibers of the web). In certain embodiments, the species may damage the component and reduce at least one structural, mechanical, and/or performance characteristics of the fiber web. One example includes filter media used for the filtration of hydraulic fluids or lubricating oils at elevated temperatures. In some instances, the filter media may comprise fibers (e.g., cellulose fibers) that can be degraded by one or more species (e.g., acid) in the hydraulic fluid or lubricating oil. The degradation can reduce the strength and overall lifetime of the filter media. Certain conventional filter media have attempted to address this problem by altering the composition of the fiber web (e.g., fiber type) to minimize or eliminate susceptible components. For example, some conventional media for filtering hot oils that contain acids have included relatively high amounts of synthetic fibers, which are typically less susceptible to degradation by acids. However, altering the composition of the fiber web may be more costly and/or may negatively influence structural, mechanical, and/or performance properties of the fiber web. For example, inclusion of high amounts of synthetic fibers in a fiber web may reduce the filtration efficiency and/or increase the cost of the fiber web.

In some embodiments, the filter media and methods described herein for protecting fiber webs from adverse interactions with species in a filtration fluid do not suffer from at least some of the limitations of conventional media. For instance, in some embodiments involving a filter media that includes a component that is susceptible to an adverse interaction with a species (e.g., an acid) in the filtration fluid, the filter media may include a scavenger capable of complexing and/or neutralizing the adverse species. The inclusion of such a scavenger can allow the media to include a relatively large percentage of the susceptible component (e.g., cellulose fibers) without negatively impacting filter performance.

In embodiments in which the adverse species is an acid, the filter media may include an acid scavenger (e.g., non-particulate acid scavenger), which may protect the cellulose fibers from being degraded in an acid-containing filtration fluid (e.g., hydraulic fluid or lubricating oil). In some such cases, the fiber web comprising the acid scavenger may have a relatively high strength (e.g., Mullen burst strength) after extended filtration (e.g., greater than or equal to about 168 hours at elevated temperature such as 110° C. to 165° C.) in an acid-containing filtration fluid. Conversely, conventional filter media comprising a similar or substantially the same percentage of cellulose fibers, but without such a scavenger, may have reduced strength after extended filtration.

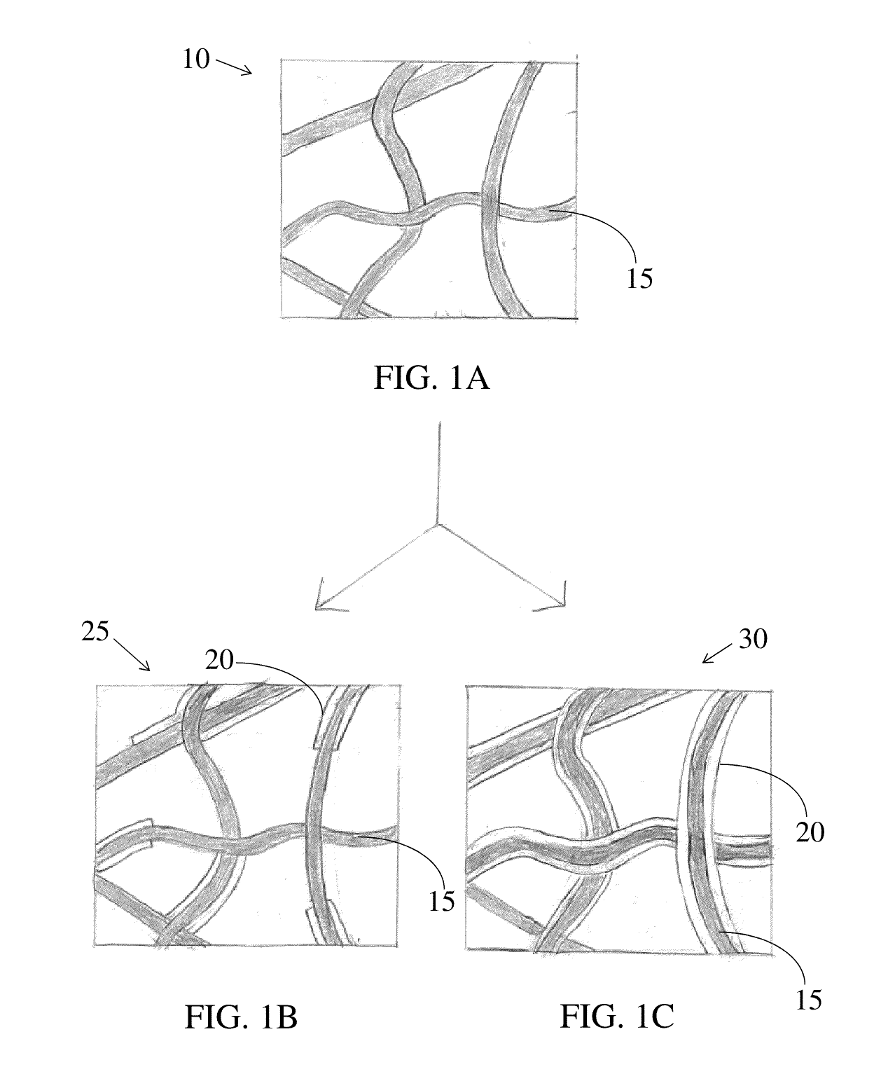

A non-limiting example of a fiber web including an acid scavenger is shown in FIG. 1. As shown illustratively in FIG. 1A, a fiber web 10, shown in cross-section, may include a plurality of fibers 15. All or portions of the fiber web may be coated with a resin 20 comprising an acid scavenger 25 distributed therein, which is shown illustratively in FIGS. 1B-C. The resin, with acid scavenger distributed within, may remain on the fiber web after the fiber web has been coated and dried. For example, in one embodiment, a coating may be formed on a surface of the fiber web. In other embodiments, the acid scavenger may be applied to the fiber web to produce a coating 30 on at least a portion of the fibers in the interior of the fiber web (i.e., through the thickness of the fiber web). In certain embodiments, substantially all of the fibers of the fiber web may be coated with the acid scavenger, as illustrated in FIG. 1C. However, in some embodiments, not all fibers are coated, e.g., as illustrated in FIG. 1B. In some embodiments, regardless of whether the surface and/or interior of the fiber web are coated, the acid scavenger and/or resin components may absorb into the surface of the fiber. In one particular example, an acid scavenger may absorb into the surface of a fiber comprising cellulose pulp. In some embodiments, the coated fiber webs 25 and 30, shown in FIGS. 1B and 1C, respectively, may be used as filter media and may have enhanced mechanical properties as described herein.

As described herein, a fiber web may include an acid scavenger. In some embodiments, the acid scavenger may be part of a resin that is coated on the fiber web. In certain embodiments, the acid scavenger may be coated on the fiber web without a resin (e.g., the acid scavenger may be attached directly to the surface of the fibers). Regardless of whether the acid scavenger is coated on the fiber web with or without a resin, in some embodiments, at least a portion of the acid scavenger may be immobilized on at least a portion of the fiber web.

In certain embodiments, immobilization of the acid scavenger on at least a portion of the fiber web may protect the fiber web from adverse interactions with species in the filtration fluid. Without being bound by theory, it is believed that the immobilized acid scavenger may complex and/or neutralize acids that are in close proximity to the fibers. In certain embodiments, the immobilized acid scavenger may alter the local concentration of acid in the vicinity of the fibers. Immobilization may prevent or reduce the amount of scavenger that is swept into the filtration fluid during filtration, where it may be undesirable to have such a species in the filtration fluid. Conversely, a mobile acid scavenger (i.e., an acid scavenger that is not immobilized in or on the web) may be swept into the filtration fluid during filtration and may complex or neutralize acid molecules in the bulk filtration fluid. In some such embodiments, a relatively high concentration of acid scavenger may be needed to neutralize or complex enough acid to protect the fibers from adverse interactions with the acid. In certain instances, the use of a relatively high concentration of a mobile acid scavenger, especially one that is present in the filtration fluid and/or in particulate form, may adversely impact the filtration fluid itself, a filter media or element, a system, and/or a method utilizing the fiber web. For example, high concentrations of a mobile particulate acid scavenger may clog at least a portion of the pores of the fiber web and reduce permeability. Immobilization may also allow a relatively large fraction of the fiber web (e.g., entire fiber web, fiber web surface) to be protected against adverse interactions with species during filtration. Conversely, for mobile acid scavengers, the percentage of the fiber web protected from adverse interactions may be dependent on the concentration of the mobile acid scavenger in the filtration fluid and the concentration of mobile acid scavenger may be limited by potential adverse effects on filtration as described above.

In some instances, substantially all of an acid scavenger included in a fiber media or filter element may be immobilized on at least a portion of the fiber web. In some cases, the acid scavenger may be a part of a resin that is immobilized on the fiber web. In certain cases, the acid scavenger may be immobilized on at least a portion of the fibers in the fiber web by a chemical bond, such as a covalent bond or a non-covalent bond (e.g. hydrogen bond, ionic bond, dative bond, and/or a Van der Waals interaction). In some such embodiments, the acid scavenger may comprise a functional group capable of forming such bonds with the fiber directly, or with a coating on the fiber. In other embodiments, an acid scavenger may be adsorbed to the surface of the fibers of the fiber web, or on a coating of the fiber web.

In some embodiments, an acid scavenger that is immobilized with respect to the fiber web may be retained in or on the fiber web during and/or after use. For instance, in some embodiments, a substantial amount of the acid scavenger may remain in or on the fiber web after extended filtration with a filtration fluid and/or after subjecting the fiber web to hydraulic fluid or lubricating oil at elevated temperatures for an extended period of time. In some embodiments, the weight percentage of the acid scavenger on the fiber web after extended filtration may be substantially the same as the weight percentage of the acid scavenger on the fiber web before filtration.

In some embodiments, the weight percentage of acid scavenger in the fiber web before the hot oil test, described herein, may be greater than or equal to about 0.001 wt %, greater than or equal to about 0.002 wt %, greater than or equal to about 0.004 wt %, greater than or equal to about 0.006 wt %, greater than or equal to about 0.008 wt %, greater than or equal to about 0.01 wt %, greater than or equal to about 0.01 wt %, greater than or equal to about 0.02 wt %, greater than or equal to about 0.03 wt %, greater than or equal to about 0.04 wt %, greater than or equal to about 0.05 wt %, greater than or equal to about 0.06 wt %, greater than or equal to about 0.08 wt %, or greater than or equal to about 0.1 wt %. In some cases, the weight percentage of acid scavenger in the fiber web may be less than or equal to about 0.5 wt %, less than or equal to about 0.4 wt %, less than or equal to about 0.3 wt %, less than or equal to about 0.2 wt %, less than or equal to about 0.1 wt %, less than or equal to about 0.09 wt %, less than or equal to about 0.08 wt %, less than or equal to about 0.07 wt %, or less than or equal to about 0.06 wt %, before a hot oil test described herein. Combinations of the above-referenced ranges are also possible (e.g., a weight percentage of acid scavenger of greater than or equal to about 0.001 wt % and less than about 0.5 wt %, greater than or equal to about 0.01 wt % and less than about 0.1 wt %). Other ranges are also possible. The weight percentage of acid scavenger in the entire fiber web is based on the dry solids and can be determined prior to coating the fiber web.

In some embodiments, the weight percentage of acid scavenger in the fiber web after the hot oil test, described herein, may be greater than or equal to about 0.001 wt %, greater than or equal to about 0.002 wt %, greater than or equal to about 0.004 wt %, greater than or equal to about 0.006 wt %, greater than or equal to about 0.008 wt %, greater than or equal to about 0.01 wt %, greater than or equal to about 0.01 wt %, greater than or equal to about 0.02 wt %, greater than or equal to about 0.03 wt %, greater than or equal to about 0.04 wt %, greater than or equal to about 0.05 wt %, greater than or equal to about 0.06 wt %, greater than or equal to about 0.08 wt %, or greater than or equal to about 0.1 wt %. In some cases, the weight percentage of acid scavenger in the fiber web may be less than or equal to about 0.5 wt %, less than or equal to about 0.4 wt %, less than or equal to about 0.3 wt %, less than or equal to about 0.2 wt %, less than or equal to about 0.1 wt %, less than or equal to about 0.09 wt %, less than or equal to about 0.08 wt %, less than or equal to about 0.07 wt %, or less than or equal to about 0.06 wt %, after a hot oil test described herein. Combinations of the above-referenced ranges are also possible (e.g., a weight percentage of acid scavenger of greater than or equal to about 0.001 wt % and less than about 0.5 wt %, greater than or equal to about 0.01 wt % and less than about 0.1 wt %). Combinations of the above-referenced ranges are also possible (e.g., a weight percentage of acid scavenger of greater than or equal to about 1 wt % and less than about 15 wt %). Other ranges are also possible.

In embodiments in which the adverse species is an acid, any suitable acid scavenger capable of complexing and/or neutralizing the acid may be used. In certain embodiments, the acid scavenger may complex, but not neutralize, one or more acids. For instance, in some embodiments, the acid scavenger associates with the acid species through a non-ionic bond. In some such embodiments, the acid scavenger may be associated with the acid species via a coordinate bond. In other embodiments, the acid scavenger may neutralize, but not complex, one or more acids. For instance, in some embodiments, the acid scavenger may neutralize the acid species through the formation of an ionic bond with the acid species.

In some embodiments, the acid scavenger may comprise at least one nitrogen atom. In some such embodiments, the acid scavenger may comprise at least one amine group. The acid scavenger may comprise, for example, a primary amine group, a secondary amine group, and/or a tertiary amine group. In some instances, the acid species may form a coordinate bond, or otherwise complex, with the acid species through a nitrogen in the acid scavenger. In certain embodiments, the scavenger may be an organic molecule (e.g., a nitrogen containing organic molecule, an amine containing organic molecule). In some embodiments, the acid species may be complexed with or neutralized by a non-oxygen atom in the acid scavenger.

Non-limiting examples of suitable acid-scavengers include ethanolamine (e.g., in mono, di- or tri-forms), aminoethylethanolamine, urea, guanidine, melamine, dicydiimide, urethane/carbonate, uralkyds, urethane modified alkyds, and combinations thereof. In some embodiments, the acid scavenger is not selected from the group consisting of a metal hydroxide and a metal oxide. It should be understood that a fiber web may include any suitable number (e.g., 1, 2, 3, 4, 5, 6) and type of acid scavengers. For example, in some embodiments, the fiber web may include a single acid scavenger. In another example, the fiber web may include a first acid scavenger of a first type (e.g., chemical composition, solubility) and a second acid scavenger of another type (e.g., having a different chemical composition and/or solubility).

In some embodiments, the acid scavengers, described herein, may be in non-particulate form. For example, the acid scavenger may be substantially soluble in a solvent (e.g., water or an organic solvent) that is used to form a resin which contains the acid scavenger. In some embodiments, the acid scavenger may be distributed within the resin or on the fiber web as isolated individual molecules or small aggregates (e.g., molecular cluster) of acid scavenger molecules. In some instances, the small aggregates of acid scavenger molecules may comprise less than or equal to about 1,000 acid scavenger molecules (e.g., less than or equal to about 750 acid scavenger molecules, less than or equal to about 500 acid scavenger molecules, less than or equal to about 100 acid scavenger molecules, less than or equal to about 100 acid scavenger molecules, less than or equal to about 75 acid scavenger molecules, less than or equal to about 50 acid scavenger molecules, less than or equal to about 25 acid scavenger molecules, less than or equal to about 10 acid scavenger molecules, less than or equal to about 5 acid scavenger molecules, less than or equal to about 4 acid scavenger molecules, less than or equal to about 3 acid scavenger molecules) and/or have a characteristic dimension (e.g., cross-sectional dimension, diameter) of less than or equal to about 5 nm (e.g., less than or equal to about 4 nm, less than or equal to about 3 nm, less than or equal to about 2 nm, less than or equal to about 1 nm, less than or equal to about 0.5 nm, less than or equal to about 0.1 nm). In some instances, the aggregate(s) may have a characteristic dimension of less than 1 nm.

In other embodiments, an acid scavenger may be in the form of a particle. The particles may have an average particle size of, for example, less than or equal to 10 microns, less than or equal to 5 microns, less than or equal to 2 microns, less than or equal to 1 micron, less than or equal to 0.5 microns, less than or equal to 0.2 microns, less than or equal to 0.1 microns, less than or equal to 0.05 microns, or less than or equal to 0.01 microns. The average particle size may be, for example, greater than about 0.001 microns, greater than or equal to about 0.002 microns, greater than or equal to about 0.004 microns, greater than or equal to about 0.006 microns, greater than or equal to about 0.008 microns, greater than or equal to about 0.01 microns, greater than or equal to about 0.05 microns, greater than or equal to about 0.1 microns. Combinations of the above-referenced ranges are also possible. Other ranges are also possible.

In some embodiments, the acid scavenger may have a certain solubility in water, e.g., greater than or equal to about 0.05 g/ml, greater than or equal to about 0.1 g/ml, greater than or equal to about 0.5 g/ml, greater than or equal to about 1.0 g/ml, greater than or equal to about 5 g/ml, or greater than or equal to about 10 g/ml, and/or less than or equal to about 1000 g/ml, less than or equal to 500 g/ml, less than or equal to about 100 g/ml, less than or equal to about 50 g/ml, less than or equal to about 10 g/ml, less than or equal to about 5 g/ml, less than or equal to about 1 g/ml, less than or equal to about 0.1 g/ml). In some embodiments, the solubility of the acid scavenger in water may be a greater than or equal to about 0.1 g/ml and less than or equal to about 1000 g/ml. In some embodiments, the acid scavenger may be a hygroscopic material. However, non-hygroscopic materials may be used in some embodiments.

In other embodiments, the acid scavenger may have a certain solubility in an organic solvent, e.g., greater than or equal to about 0.05 g/ml, greater than or equal to about 0.1 g/ml, greater than or equal to about 0.5 g/ml, greater than or equal to about 1.0 g/ml, greater than or equal to about 5 g/ml, or greater than or equal to about 10 g/ml, and/or less than or equal to about 1000 g/ml, less than or equal to 500 g/ml, less than or equal to about 100 g/ml, less than or equal to about 50 g/ml, less than or equal to about 10 g/ml, less than or equal to about 5 g/ml, less than or equal to about 1 g/ml, less than or equal to about 0.1 g/ml.

In general, the resin may have any suitable composition. The resin may comprise a thermoplastic, a thermoset, or a combination thereof. For example, the resin may include one or more of the following resins: acrylic, acrylic (e.g., acrylic thermoset resin), epoxy, vinyl acrylic, latex emulsion, nitrile, styrene, styrene-acrylic, styrene butadiene rubber, polyvinyl chloride, ethylene vinyl chloride, polyolefin, polyvinyl halide, polyvinyl ester, polyvinyl ether, polyvinyl sulfate, polyvinyl phosphate, polyvinyl amine, polyamide, polyimide, polyoxidiazole, polytriazol, polycarbodiimide, polysulfone, polycarbonate, polyether, polyarylene oxide, polyester, polyarylate, phenolics, phenol-formaldehyde, melamine-formaldehyde, formaldehyde-urea, vinyl acetate, ethylene vinyl acetate, ethyl-vinyl acetate copolymer, and/or other suitable compositions. The resin may be anionic, cationic, or non-ionic in nature. The resin may be provided as an aqueous or non-aqueous solvent-based system.

In some embodiments, the resin used to form a coating on a fiber web described herein may be a water-based resin (e.g., a water-based polymeric resin). Non-limiting examples of water-based polymer resins include acrylic resins, stryene resins, polyvinyl alcohol resins, and vinyl acetate resins, and combinations thereof. It should be appreciated that any suitable water-based polymeric resin may be utilized. In other embodiments, the resin used to form a coating on a fiber web may be a non-aqueous solvent-based resin (e.g., an organic solvent-based polymeric resin). Organic solvents include, for example, methanol, ethanol, acetone, other aliphatic alcohols, aromatic alcohols, aromatic ketones, esters, reactive diluents, nitrile solvents, ethers, chlorinated solvents, aliphatic solvents, amide solvents, lactam solvents, sulfoxides, sulfone solvents, acid and acid anhydride solvents, carbon dioxide, and carbon disulfide. Non-limiting examples of organic solvent-based resins include resole, novolac, polyesters, polyamides, polyphenols, epoxides, polyepoxides, polyurethanes, polycarbonates, polyterpenes, furan polymers, polyimides, and combinations thereof. In some embodiments, resins including mixtures of water and organic solvents (e.g., water-miscible organic solvents) can be used. Combinations of aqueous-based and non-aqueous based resins are also possible.

In some embodiments, the resin includes a cure agent. Any suitable cure agent can be used. Non-limiting examples of cure agents include hexamethylene tetramine, terpene phenolic, bismaleimides, cyanate esters, methylol melamine, methylol urea, isocyanate resins, and combinations thereof.

The amount of resin in a fiber web may vary. For example, the weight percentage of resin in the fiber web may be between 0 wt % and 50 wt %. In some embodiments, the weight percentage of resin in the fiber web may be greater than or equal to about 2 wt %, greater than or equal to about 5 wt %, greater than or equal to about 10 wt %, greater than or equal to about 15 wt %, greater than or equal to about 20 wt %, greater than or equal to about 25 wt %, greater than or equal to about 30 wt %, greater than or equal to about 35 wt %, greater than or equal to about 40 wt %, or greater than or equal to about 45 wt %. In some cases, the weight percentage of resin in the fiber web may be less than or equal to about 50 wt %, less than or equal to about 45 wt %, less than or equal to about 40 wt %, less than or equal to about 35 wt %, less than or equal to about 30 wt %, less than or equal to about 25 wt %, less than or equal to about 20 wt %, less than or equal to about 15 wt %, less than or equal to about 10 wt %, or less than or equal to about 5 wt %. Combinations of the above-referenced ranges are also possible (e.g., a weight percentage of resin of greater than or equal to about 5 wt % and less than about 40 wt %). Other ranges are also possible. The weight percentage of resin in the entire fiber web is based on the dry solids and can be determined prior to coating the fiber web.

The resin may have any suitable weight percentage of acid scavenger distributed therein. For instance, in some embodiments, the weight percentage of acid scavenger in the resin may be greater than or equal to about 0.01 wt %, greater than or equal to about 0.02 wt %, greater than or equal to about 0.03 wt %, greater than or equal to about 0.04 wt %, greater than or equal to about 0.06 wt %, greater than or equal to about 0.08 wt %, greater than or equal to about 0.1 wt %, greater than or equal to about 0.2 wt %, greater than or equal to about 0.5 wt %, or greater than or equal to about 1 wt %. In some instances, the weight percentage of acid scavenger in the resin may be less than or equal to about 2 wt %, less than or equal to about 1.5 wt %, less than or equal to about 1.2 wt %, less than or equal to about 1 wt %, less than or equal to about 0.8 wt %, less than or equal to about 0.6 wt %, less than or equal to about 0.5 wt %, or less than or equal to about 0.4 wt %. Combinations of the above-referenced ranges are also possible (e.g., greater than or equal to about 0.01 wt % and less than or equal to about 2 wt %, greater than or equal to about 0.1 wt % and less than or equal to about 1 wt %). Other values of weight percentage of acid scavenger in the resin are also possible. The weight percentage of acid scavenger in the resin is based on the dry resin solids and can be determined prior to coating the fiber web.

To form a resin containing an acid scavenger and/or other components, the acid scavenger and/or other components to be included in the resin may first be added in a specific amount to a solution or suspension (e.g., water or other solvent). A resin (and any optional additives) may then be combined and mixed with the solution or suspension containing the acid scavenger and/or other components. It should be understood that this method of resin formulation is not limiting and other methods of resin formulation are possible. A resin containing acid scavenger and/or other components therein may be added to the fiber web in any suitable manner (e.g., in the wet state or in the dry state) after the fiber web is formed and/or during formation of the fiber web.

It should be understood that the resin may, or may not, include other components in addition to those described above. Typically, any additional components are present in limited amounts, e.g., less than 20% by weight of the resin, less than 10% by weight of the resin, less than 5% by weight of the resin. For example, in some embodiments, the resin may include, antioxidants, natural polymers (starches, gums), cellulose derivatives, such as carboxymethyl cellulose, methylcellulose, hemicelluloses, synthetic polymers such as phenolics, latexes, polyamides, polyacrylamides, urea-formaldehyde, melamine-formaldehyde, polyamides), surfactants, coupling agents, crosslinking agents, and/or conductive additives, amongst others. In another example, the resin may include may include one or more of a viscosity modifier (e.g., acrylic acid), a water repellant (e.g., a long hydrocarbon chained molecule and/or a fluorine-containing molecule), a cross-linker (e.g., urea-formaldehyde), and/or pH adjuster (e.g., ammonia).

In some embodiments, the resin may include an antioxidant. The antioxidant may reduce or prevent oxidation; oxidation may damage the fiber web and/or increase the concentration of acid species in the filtration fluid. In some instances, the antioxidant may reduce the rate of oxidation in and/or amount of oxidized species in the hydraulic fluid or lubricating oil, such that acid formation is reduced. In certain embodiments, the combination of the acid scavenger and the antioxidant may have an additive or synergistic effect on the strength (e.g., Mullen burst strength) of the fiber web during and after filtration, e.g., in a hot hydraulic fluid or lubricating oil.

In some embodiments, at least a portion of the antioxidant may be immobilized on at least a portion of the fiber web. In some instances, substantially all of the antioxidant included in a fiber media or filter element may be immobilized on at least a portion of the fiber web. In some embodiments, an acid scavenger that is immobilized with respect to the fiber web may be retained in or on the fiber web during and/or after use. For instance, in some embodiments, a substantial amount of the antioxidant may remain in or on the fiber web after extended filtration with a filtration fluid and/or after subjecting the fiber web to a hot hydraulic fluid or lubricating oil for an extended period of time.

In general, any suitable antioxidant may be used. Non-limiting examples of antioxidants include phenolic compounds, azole compounds (e.g., thiazoles, thiadiazoles, triazoles), arylamino compounds, thiophosphates (e.g., zinc dithiophosphates, zinc dialkyl dithiophosphates), and sulfides (e.g., aromatic sulfides, aromatic polysulfides, alkyl sulfides, alkyl polysulfides), and combinations thereof.

In some embodiments, the antioxidant, described herein, may be in non-particulate form. For example, the antioxidant may be substantially soluble in a solvent (e.g., water or an organic solvent) that is used to form a resin which contains the acid scavenger. In some embodiments, the antioxidant may be distributed within the resin or on the fiber web as isolated individual molecules or small aggregates (e.g., molecular cluster) of antioxidant molecules, as described above with respect to the acid scavenger. In other embodiments, an antioxidant may be in the form of a particle.

The amount of antioxidant in a fiber web may vary. For example, the weight percentage of antioxidant in the fiber web may be between 0.1 wt % and 15 wt %. In some embodiments, the weight percentage of antioxidant in the fiber web may be greater than or equal to about 0.1 wt %, greater than or equal to about 1 wt %, greater than or equal to about 2 wt %, greater than or equal to about 3 wt %, greater than or equal to about 4 wt %, greater than or equal to about 5 wt %, greater than or equal to about 6 wt %, greater than or equal to about 8 wt %, greater than or equal to about 10 wt %, greater than or equal to about 12 wt %, or greater than or equal to about 14 wt %. In some cases, the weight percentage of antioxidant in the fiber web may be less than or equal to about 15 wt %, less than or equal to about 14 wt %, less than or equal to about 13 wt %, less than or equal to about 12 wt %, less than or equal to about 10 wt %, less than or equal to about 8 wt %, less than or equal to about 6 wt %, less than or equal to about 5 wt %, less than or equal to about 4 wt %, or less than or equal to about 2 wt %. Combinations of the above-referenced ranges are also possible (e.g., a weight percentage of antioxidant of greater than or equal to about 1 wt % and less than about 15 wt %). Other ranges are also possible. The weight percentage of antioxidant in the entire fiber web is based on the dry solids and can be determined prior to coating the fiber web.

Any suitable method may be used to form a coating on the fiber web. In some embodiments, a coating process involves introducing resin into a pre-formed fiber layer (e.g., a pre-formed fiber web formed by a wet-laid process). In some embodiments, as the fiber layer is passed along an appropriate screen or wire, different components included in the resin, such as an acid scavenger described herein, which may be in the form of separate emulsions, are added to the fiber layer using a suitable technique. In some cases, each component of the resin is mixed as an emulsion prior to being combined with the other components and/or fiber layer. In some embodiments, the components included in the resin may be pulled through the fiber layer using, for example, gravity and/or vacuum. In some embodiments, one or more of the components included in the resin may be diluted with softened water and pumped into the fiber layer. In some embodiments, a resin may be applied to a fiber slurry prior to introducing the slurry into a headbox. For example, the resin may be introduced (e.g., injected) into the fiber slurry and impregnated with and/or precipitated on to the fibers. In some embodiments, a resin may be added to a fiber web by a solvent saturation process.

In some embodiments, the resin comprising an acid scavenger may be applied to the fiber web using a non-compressive coating technique. The non-compressive coating technique may coat the fiber web, while not substantially decreasing the thickness of the web. In other embodiments, the resin may be applied to the fiber web using a compressive coating technique. Non-limiting examples of coating methods include the use of a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, melt coating, dip coating, knife roll coating, spin coating, spray coating, gapped roll coating, roll transfer coating, padding saturant coating, and saturation impregnation. Other coating methods are also possible.

After applying the resin to the fiber web, the resin may be dried by any suitable method. Non-limiting examples of drying methods include the use of a infrared dryer, hot air oven, steam-heated cylinder, through air dryer, hot air float oven, or any suitable type of dryer familiar to those of ordinary skill in the art.

The resin may coat any suitable portion of the fiber web. In some embodiments, the coating of resin may be formed such that the surfaces of the fiber web are coated without substantially coating the interior of the fiber web. In some instances, a single surface of the fiber web may be coated. For example, a top surface or layer of the fiber web may be coated. In other instances, more than one surface or layer of the fiber web may be coated (e.g., the top and bottom surfaces or layers). In other embodiments, at least a portion of the interior of the fiber web may be coated without substantially coating at least one surface or layer of the fiber web. For example, a middle layer of a fiber web may be coated, but one or more layers adjacent to the middle layer may not be coated. The coating may also be formed such that at least one surface or layer of the fiber web and the interior of the fiber web are coated. In some embodiments, the entire web is coated with the resin.

In some embodiments, at least a portion of the fibers of the fiber web may be coated without substantially blocking the pores of the fiber web. In some instances, substantially all of the fibers may be coated without substantially blocking the pores. In some embodiments, the fiber web may be coated with a relatively high weight percentage of resin without blocking the pores of the resin using the methods described herein (e.g., by dissolving and/or suspending one or more components in a solvent to form the resin). Coating the fibers of the web using the resins described herein may add strength and/or flexibility to the fiber web, and leaving the pores substantially unblocked may be important for maintaining or improving certain filtration properties such as air permeability.

In some embodiments, the fiber web may include more than one coating (e.g., on different surfaces of the fiber web). In some cases, the same coating method may be utilized to apply more than one coating. For example, the same coating method may be used to form a first coating on a top surface and a second coating on a bottom surface of the fiber web. In other instances, more than one coating method may be used to apply more than one coating. For example, a first coating method may be used to form a first coating in the interior of the fiber web and a second coating method may be used to form a second coating on a bottom surface of the fiber web. When more than one coating exists on a fiber web, in some embodiments the coatings may have the same resin composition. In other embodiments, the resin compositions may differ with respect to certain properties (e.g., first component, second component, ratio of components).

In some embodiments a method of forming a coated fiber web includes applying a pre-polymerized resin to a fiber web. In other embodiments, at least portions of the resin (or components of the resin) may be polymerized after applying the resin to the fiber web.

In some embodiments, the fiber webs described herein may include cellulose fibers. The cellulose fibers may include any suitable type of cellulose fibers such as softwood fibers, hardwood fibers, and mixtures thereof. Moreover, the cellulose fibers may include natural cellulose fibers, synthetic cellulose fibers, or mixtures thereof. The cellulose fibers may be fibrillated or non-fibrillated. Mixtures of cellulose fibers are also possible.

The fiber web may include a suitable percentage of cellulose fibers. For example, in some embodiments, the weight percentage of cellulose fibers may be between about 0 wt % and about 100 wt % of all fibers in the web. In some embodiments, the weight percentage of cellulose fibers may be greater than or equal to about 5 wt %, greater than or equal to about 10 wt %, greater than or equal to about 20 wt %, greater than or equal to about 40 wt %, greater than or equal to about 60 wt %, greater than or equal to about 80 wt %, greater than or equal to about 90 wt %, greater than or equal to about 95 wt %, or greater than or equal to about 98 wt % of all fibers in the web. In some embodiments, the weight percentage of the cellulose fibers in the fiber web may be less than or equal to about 100 wt %, less than or equal to about 98 wt %, less than or equal to about 95 wt %, less than or equal to about 90 wt %, less than or equal to about 80 wt %, less than or equal to about 70 wt %, less than or equal to about 50 wt %, less than or equal to about 40 wt %, less than or equal to about 20 wt %, less than or equal to about 10 wt %, or less than or equal to about 5 wt % of all fibers in the web. Combinations of the above-referenced ranges are also possible (e.g., a weight percentage of greater than about 40 wt % and less than or equal to about 80 wt % of all fibers in the web). Other ranges are also possible. In some embodiments, a fiber web includes 0 wt % of cellulose fibers. In some embodiments, a fiber web includes 0 wt % of cellulose fibers. In other embodiments, a fiber web includes 100 wt % of cellulose fibers. In some embodiments, a fiber web includes the above-noted ranges of cellulose fibers with respect to the total weight of the fiber web (e.g., including the resin).

In some embodiments, in which the fiber web includes cellulose fibers, the average diameter of the cellulose fibers in the fiber web may be, for example, greater than or equal to about 1 micron, greater than or equal to about 5 microns, greater than or equal to about 10 microns, greater than or equal to about 20 microns, greater than or equal to about 30 microns, greater than or equal to about 40 microns, greater than or equal to about 50 microns, or greater than or equal to about 60 microns. In some instances, the cellulose fibers may have an average diameter of less than or equal to about 75 microns, less than or equal to about 65 microns, less than or equal to about 55 microns, less than or equal to about 45 microns, less than or equal to about 35 microns, less than or equal to about 25 microns, less than or equal to about 15 microns, or less than or equal to about 5 microns. Combinations of the above-referenced ranges are also possible (e.g., greater than or equal to about 2 microns and less than or equal to about 75 microns, greater than or equal to about 1 micron and less than or equal to about 5 microns). Other values of average fiber diameter are also possible.

In some embodiments, the cellulose fibers may have an average length. For instance, in some embodiments, cellulose fibers may have an average length of greater than or equal to about 0.5 mm, greater than or equal to about 1 mm, greater than or equal to about 3 mm, greater than or equal to about 6 mm, greater than or equal to about 8 mm, greater than or equal to about 10 mm, greater than or equal to about 15 mm, or greater than or equal to about 20 mm. In some instances, cellulose fibers may have an average length of less than or equal to about 25 mm, less than or equal to about 20 mm, less than or equal to about 15 mm, less than or equal to about 12, less than or equal to about 10 mm, less than or equal to about 4 mm, less than or equal to about 2 mm, or less than or equal to about 1 mm. Combinations of the above-referenced ranges are also possible (e.g., greater than or equal to about 0.1 mm and less than or equal to about 15 mm, greater than or equal to about 1 mm and less than or equal to about 4 mm). Other values of average fiber length are also possible.

A fiber web may include any suitable amount of hardwood and/or softwood fibers. Mixtures of hardwood and/or softwood fibers are also possible.

In some embodiments, the weight percentage of hardwood fibers in the fiber web may be between about 0 wt % and about 100 wt % of all fibers in the web. In some embodiments, the weight percentage of hardwood fibers in the fiber web may be greater than or equal to about 5 wt %, greater than or equal to about 25 wt %, greater than or equal to about 50 wt %, or greater than or equal to about 80 wt %. In some embodiments, the weight percentage of the hardwood fibers in the fiber web may be less than or equal to about 100 wt %, less than or equal to about 60 wt %, less than or equal to about 30 wt %, or less than or equal to about 5 wt %. Combinations of the above-referenced ranges are also possible (e.g., a weight percentage of greater than about 5 wt % and less than or equal to about 100 wt %). Other ranges are also possible. In some embodiments, a fiber web includes 0 wt % of hardwood fibers. In some embodiments, a fiber web includes 100 wt % of hardwood fibers. In some embodiments, a fiber web includes the above-noted ranges of hardwood fibers with respect to the total weight of fibers in the web.

The weight percentage of softwood fibers in the fiber web may also vary. For example, the weight percentage of softwood fibers in the fiber web may be between about 0 wt % and about 98 wt %. In some embodiments, the weight percentage of softwood fibers in the fiber web may be greater than or equal to about 5 wt %, greater than or equal to about 10 wt %, greater than or equal to about 30 wt %, greater than or equal to about 60 wt %, greater than or equal to about 90 wt %, or greater than or equal to about 98 wt %. In some embodiments, the weight percentage of the softwood fibers in the fiber web may be less than or equal to about 98 wt %, less than or equal to about 80 wt %, less than or equal to about 50 wt %, less than or equal to about 20 wt %, or less than or equal to about 5 wt %. Combinations of the above-referenced ranges are also possible (e.g., a weight percentage of greater than about 5 wt % and less than or equal to about 80 wt %). Other ranges are also possible. In some embodiments, a fiber web includes 0 wt % of softwood fibers. In some embodiments, a fiber web includes 100 wt % of softwood fibers. In some embodiments, a fiber web includes the above-noted ranges of softwood fibers with respect to the total weight of fibers in the web.

In some embodiments, the fiber webs described herein include one or more synthetic fibers. Synthetic fibers may include any suitable type of synthetic polymer. Examples of suitable synthetic fibers include polyester, polyamide, polyaramid, polyimide, polyethylene, polypropylene, polyether ether ketone, polyethylene terephthalate, polyolefin, nylon, acrylics, polyvinyl alcohol, regenerated cellulose (e.g., lyocell, rayon), and combinations thereof. In some embodiments, the synthetic fibers are organic polymer fibers. Synthetic fibers may also include multi-component fibers (i.e., fibers having multiple compositions such as bi-component fibers). The fiber web may also include combinations of more than one type of composition of synthetic fiber. It should be understood that other compositions of synthetic fiber types may also be used.

In some embodiments, synthetic fibers may be staple fibers, which may be synthetic fibers that are cut to a suitable average length and are appropriate for incorporation into a wet-laid or dry-laid process for forming a fiber web. In some cases, groups of staple fibers may be cut to have a particular length with only slight variations in length between individual fibers.

In some embodiments, synthetic fibers may be binder fibers, as described in more detail below.

Fiber webs including combinations of different types of synthetic fibers are also possible.

A fiber web may include a suitable percentage of synthetic fibers, although in some embodiments, relatively low amounts of synthetic fibers may be included. In some embodiments, the weight percentage of synthetic fibers in the fiber web may be less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, less than or equal to about 10 wt %, less than or equal to about 5 wt %, less than or equal to about 4 wt %, less than or equal to about 2 wt %, less than or equal to about 1 wt %, or less than or equal to about 0.5 wt %. In some embodiments, the weight percentage of the synthetic fibers in the fiber web may be greater than or equal to about 0.1 wt %, greater than or equal to about 1 wt %, greater than or equal to about 5 wt %, greater than or equal to about 10 wt %, greater than or equal to about 20 wt %, greater than or equal to about 30 wt %, greater than or equal to about 50 wt %, or greater than or equal to about 70 wt %. Combinations of the above-referenced ranges are also possible (e.g., a weight percentage of greater than about 0.1 wt % and less than or equal to about 30 wt %). Other ranges are also possible. In some embodiments, a fiber web includes 0 wt % of synthetic fibers. When the fiber web includes less than 1 wt % of synthetic fiber, it is considered that the fiber web is substantially free of synthetic fibers. In some embodiments, a fiber web includes the above-noted ranges of synthetic fibers with respect to the total weight of fibers in the web.

In general, synthetic fibers may have any suitable dimensions. For instance, synthetic fibers may have an average diameter of between about 2 microns and about 50 microns, between about 2 microns and about 20 microns, between about 4 microns and about 7 microns, or between about 3 microns and about 7 microns. In some embodiments, the synthetic fibers may have an average diameter of greater than or equal to about 1 micron, greater than or equal to about 2 microns, greater than or equal to about 4 microns, greater than or equal to about 6 microns, greater than or equal to about 8 microns, greater than or equal to about 10 microns, greater than or equal to about 12 microns, greater than or equal to about 15 microns, greater than or equal to about 20 microns, greater than or equal to about 30 microns, or greater than or equal to about 40 microns. In some cases, the synthetic fibers may have an average diameter of less than or equal to about 50 microns, less than or equal to about 40 microns, less than or equal to about 30 microns, less than or equal to about 20 microns, less than or equal to about 15 microns, less than or equal to about 12 microns, less than or equal to about 10 microns, than or equal to about 8 microns, less than or equal to about 6 microns, less than equal to about 4 microns, or less than or equal to about 2 microns. Combinations of the above referenced ranges are also possible (e.g., an average diameter of greater than or equal to about 2 microns and less than about 10 microns). Other ranges are also possible. In some embodiments, synthetic fibers may have an average length of between about 3 mm and about 12 mm, between about 4 mm and about 6 mm, or between about 5 mm and about 7 mm.

As described herein, in some embodiments, at least a portion of the synthetic fibers may be binder fibers. In some embodiments, the binder fiber may enhance the strength of the media. In some such embodiments, the combination of a binder fiber with an acid scavenger and/or other components (e.g., antioxidant) may have an additive or synergistic effect on the strength (e.g., Mullen burst) of the fiber web during and after filtration in a hot hydraulic fluid or lubricating oil (e.g., synthetic oil). The binder fibers may be mono-component (i.e., having a single composition) or multi-component (i.e., having multiple compositions such as bi-component fiber). The fiber web may include a suitable percentage of mono-component fibers and/or multi-component fibers. In some embodiments, all of the synthetic fibers are mono-component fibers. In some embodiments, at least a portion of the synthetic fibers are multi-component fibers. In some embodiments, the fiber web may comprise a residue from a binder fiber.

An example of a multi-component fiber is a bi-component fiber which includes a first material and a second material that is different from the first material. The different components of a multi-component fiber may exhibit a variety of spatial arrangements. For example, multi-component fibers may be arranged in a core-sheath configuration (e.g., a first material may be a sheath material that surrounds a second material which is a core material), a side by side configuration (e.g., a first material may be arranged adjacent to a second material), a segmented pie arrangement (e.g., different materials may be arranged adjacent to one another in a wedged configuration), a tri-lobal arrangement (e.g., a tip of a lobe may have a material different from the lobe) and an arrangement of localized regions of one component in a different component (e.g., “islands in sea”).

In some embodiments, for a core-sheath configuration, a multi-component fiber, such as a bi-component fiber, may include a sheath of a first material that surrounds a core comprising a second material. In such an arrangement, for some embodiments, the melting point of the first material may be lower than the melting point of the second material. Accordingly, at a suitable step during manufacture of a fiber web (e.g., drying), the first material comprising the sheath may be melted (e.g., may exhibit a phase change) while the second material comprising the core remains unaltered (e.g., may exhibit no phase change). For instance, an outer sheath portion of a multi-component fiber may have a melting temperature between about 50° C. and about 200° C. (e.g., 180° C.) and an inner core of the multi-component fiber may have a melting temperature above 200° C. As a result, when the fiber is subjected to a temperature during drying, e.g., at 180° C., then the outer sheath of the fiber may melt while the core of the fiber does not melt.

Suitable compositions for binder fibers include polyesters (e.g., co-polyester, PET, undrawn PET, coPET), vinyl compounds (e.g., polyvinyl chloride, polyvinyl alcohol, vinyl acetate, polyvinyl acetate, ethylene vinyl acetate), polyolefins (e.g., PE, PP), polyurethanes, and polyamides (e.g., co-polyamide) materials. These compositions may be used as single component or in multi-component binder fibers. Examples of suitable multi-component fibers include polyolefin (e.g., polyethylene (HDPE, LLDPE), polypropylene)/polyester, coPET (e.g., melt amorphous, melt crystalline)/polyester, coPET/nylon, and PET/PPS. In this listing of multi-component fibers, the convention is to list the material having the lower melting temperature (e.g., first material) separated from the material having the higher melting temperature (e.g., second material) with a “/”. Other suitable compositions are known to those of skill in the art. In some embodiments, the binder fiber may include a vinyl compounds (e.g., polyvinyl alcohol).

A fiber web may include a suitable percentage of binder fibers (or a residue from binder fibers). For example, in some embodiments, the weight percentage of binder fibers (or a residue from binder fibers) in the fiber web may be between about 0 wt % and about 50 wt %. In some embodiments, the weight percentage of binder fibers in the fiber web may be less than or equal to about 50 wt %, less than or equal to about 40 wt %, less than or equal to about 30 wt %, less than or equal to about 20 wt %, less than or equal to about 10 wt %, less than or equal to about 5 wt %, less than or equal to about 3 wt %, or less than or equal to about 1 wt %. In some embodiments, the weight percentage of the binder fibers (or a residue from binder fibers) in the fiber web may be greater than or equal to about 0 wt %, greater than or equal to about 1 wt %, greater than or equal to about 5 wt %, greater than or equal to about 10 wt %, greater than or equal to about 15 wt %, greater than or equal to about 25 wt %, or greater than or equal to about 40 wt %. Combinations of the above-referenced ranges are also possible (e.g., a weight percentage of greater than about 0 wt % and less than or equal to about 25 wt %). Other ranges are also possible. In some embodiments, a fiber web includes 0 wt % of binder fibers. For example, a binder fiber may not be included due to certain manufacturing methods and/or equipment limitations. In some embodiments, a fiber web includes the above-noted ranges of binder fibers with respect to the total weight of fibers in the web.

The fiber web may include limited amounts of, if any, glass fibers. For example, the weight percentage of glass fiber in the fiber web may be between about 0 wt % and about 50 wt % (e.g., between about 0 wt % and about 15 wt %). In some embodiments, the weight percentage of glass fibers in the fiber web may be less than or equal to about 50 wt %, less than or equal to about 40 wt %, less than or equal to about 30 wt %, less than or equal to about 20 wt %, less than or equal to about 10 wt %, less than or equal to about 5 wt %, less than or equal to about 3 wt %, or less than or equal to about 1 wt %. In some embodiments, the weight percentage of glass fibers in the fiber web may be greater than or equal to about 0 wt %, greater than or equal to about 5 wt %, greater than or equal to about 10 wt %, greater than or equal to about 20 wt %, greater than or equal to about 30 wt %, or greater than or equal to about 40 wt %. Combinations of the above-referenced ranges are also possible (e.g., a weight percentage of greater than about 0 wt % and less than or equal to about 15 wt %). In some embodiments, a fiber web includes 0 wt % of glass fibers. When the fiber web includes less than 1 wt % of glass fiber, it is considered that the fiber web is substantially free of glass fiber. Other ranges are also possible. In some embodiments, a fiber web includes the above-noted ranges of glass fibers with respect to the total weight of fibers in the web.

As noted above, the fiber webs described herein may include one or more fibrillated fibers, which can increase the surface area of the fiber web. A fibrillated fiber may be formed of any suitable materials such as synthetic materials (e.g., synthetic polymers such as polyester, polyamide, polyaramid, polyimide, polyethylene, polypropylene, polyether ether ketone, polyethylene terephthalate, polyolefin, nylon, acrylics, regenerated cellulose (e.g., lyocell, rayon), poly p-phenylene-2,6-bezobisoxazole (PBO), and natural materials (e.g., natural polymers such as cellulose (e.g., non-regenerated cellulose, liquid crystalline polymers, polyoxazole (e.g., poly(p-phenylene-2,6-benzobisoxazole), aramid, paramid, cellulose wood, cellulose acetate, cellulose non-wood, cotton, polyethylene, polyolefin and olefin, amongst others)). In some embodiments, organic polymer fibers are used.

It can be appreciated that fibrillated fibers may include any suitable combination of synthetic and/or non-synthetic fibers.

In general, the fibrillated fibers included in a fiber web may have any suitable level of fibrillation. The level of fibrillation relates to the extent of branching in the fiber. The level of fibrillation may be measured according to any number of suitable methods. For example, the level of fibrillation of the fibrillated fibers can be measured according to a Canadian Standard Freeness (CSF) test, specified by TAPPI test method T 227 om 09 Freeness of pulp. The test can provide an average CSF value. In some embodiments, the average CSF value of the fibrillated fibers used in a fiber web may vary between about 10 mL and about 700 mL (e.g., between about 10 mL and about 400 mL, between about 100 mL and about 400 mL, between about 300 mL and about 700 mL, or between about 50 mL and about 500 mL).

The average CSF value of the fibrillated fibers used in a fiber web may be based on one type of fibrillated fiber or more than one type of fibrillated fiber.

It should be understood that, in certain embodiments, the fibers may have fibrillation levels outside the above-noted ranges.

In general, the fibrillated fibers may have any suitable dimensions (e.g., dimensions measured via a microscope).

As noted above, fibrillated fibers include parent fibers and fibrils. The parent fibers may have an average diameter of, for example, between about 0.3 micron about 75 microns (e.g., between about 0.3 micron and about 30 microns, between about 15 microns and about 50 microns, or between about 40 microns and about 75 microns).

The fibrillated fibers described may have an average length of, for example, between about 1 mm and about 15 mm (e.g., between about 0.2 and about 12 mm, or between about 2 mm and about 4 mm).

In general, the fiber web may include any suitable weight percentage of fibrillated fibers to achieve the desired balance of properties. In some embodiments, the weight percentage of the fibrillated fibers in the fiber web is between about 0 wt % and about 100 wt % (e.g., between about 0 wt % and about 50 wt %). For instance, the weight percentage of fibrillated fibers in the fiber web may be greater than or equal to about 0 wt %, greater than or equal to about 2 wt %, greater than or equal to about 10 wt %, greater than or equal to about 20 wt %, greater than or equal to about 40 wt %, greater than or equal to about 60 wt %, or greater than or equal to about 80 wt %. In some embodiments, the weight percentage of the fibrillated fibers in the web is less than or equal to about 100 wt %, less than or equal to about 80 wt %, less than or equal to about 50 wt %, less than or equal to about 40 wt %, less than or equal to about 20 wt less than or equal to about 10 wt %, or less than or equal to about 5 wt %. Combinations of the above-referenced ranges are also possible (e.g., a weight percentage of greater than about 0 wt % and less than or equal to about 40 wt %). Other ranges are also possible. In some embodiments, a fiber web includes the above-noted ranges of fibrillated fibers with respect to the total weight of fibers in the web.

The basis weight of the fiber web can typically be selected as desired. In some embodiments, the basis weight of the fiber web may range from between about 5 and about 1000 g/m². For instance, the basis weight of the fiber web may be between about 40 and about 400 g/m², between about 30 and about 300 g/m², between about 50 and about 200 g/m², between about 90 g/m² and about 200 g/m², between about 90 g/m² and about 150 g/m². In some embodiments, the basis weight of the fiber web may be greater than or equal to about 5 g/m² (e.g., greater than or equal to about 10 g/m², greater than or equal to about 40 g/m², greater than or equal to about 75 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², or greater than or equal to about 400 g/m²). In some cases, the basis weight of the fiber web may be less than or equal to about 1000 g/m² (e.g., less than or equal to about 700 g/m², less than or equal to about 500 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 75 g/m², or less than or equal to about 50 g/m²). Combinations of the above-referenced ranges are also possible (e.g., a basis weight of greater than about 40 g/m² and less than or equal to about 400 g/m²). Other ranges are also possible. As determined herein, the basis weight of the fiber web is measured according to the TAPPI T410 Standard. Values are expressed in grams per square meter.

Thickness, as referred to herein, is determined according to the Standard TAPPI T411 (e.g., in an uncorrugated form). The thickness of the fiber web may be between about 0.1 mm and about 10 mm. In some embodiments, the thickness of the fiber web may be greater than or equal to about 0.3 mm, greater than or equal to about 0.5 mm, greater than or equal to about 0.6 mm, greater than or equal to about 0.8 mm, greater than or equal to about 1.0 mm, greater than or equal to about 1.2 mm, greater than or equal to about 1.5 mm, greater than or equal to about 2 mm, greater than or equal to about 3 mm, greater than or equal to about 4 mm, greater than or equal to about 5 mm, or greater than or equal to about 7 mm. In certain embodiments, the thickness of the fiber web may be less than or equal to about 10 mm, less than or equal to about 7 mm, less than or equal to about 5 mm, less than or equal to about 4 mm, less than or equal to about 2 mm, less than or equal to about 1.2 mm, less than or equal to about 1.0 mm, less than or equal to about 0.8 mm, less than or equal to about 0.6 mm, or less than or equal to about 0.4 mm, less than or equal to about 0.2 mm. Combinations of the above-referenced ranges are also possible (e.g., a thickness of greater than about 0.3 mm and less than or equal to about 4.0 mm). Other ranges are also possible.

The fiber web may exhibit a suitable mean flow pore size. Mean flow pore size, as determined herein, is measured according to Standard ASTM F316. In some embodiments, the mean flow pore size may range between about 0.1 microns and about 75 microns (e.g., between about 0.1 microns and about 50 microns, between about 5 microns and about 40 microns, between about 15 microns and about 40 microns, or between about 25 microns and about 40 microns). In some embodiments, the mean flow pore size of the fiber web may be less than or equal to about 75 microns, less than or equal to about 60 microns, less than or equal to about 50 microns, less than or equal to about 45 microns, less than or equal to about 40 microns, less than or equal to about 30 microns, less than or equal to about 25 microns, less than or equal to about 20 microns, less than or equal to about 15 microns, less than or equal to about 10 microns, or less than or equal to about 5 microns, less than or equal to about 3 microns, less than or equal to about 2 microns, less than or equal to about 1 micron, less than or equal to about 0.8 microns, less than or equal to about 0.5 microns, or less than or equal to about 0.2 microns. In other embodiments, the mean flow pore size may be greater than or equal to about 0.1 microns, greater than or equal to about 0.2 microns, greater than or equal to about 0.5 microns, greater than or equal to about 0.8 microns, greater than or equal to about 1 micron, greater than or equal to about 2 microns, greater than or equal to about 5 microns, greater than or equal to about 10 microns, greater than or equal to about 15 microns, greater than or equal to about 20 microns, greater than or equal to about 25 microns, greater than or equal to about 30 microns, greater than or equal to about 35 microns, greater than or equal to about 50 microns or greater than or equal to about 60 microns. Combinations of the above-referenced ranges are also possible (e.g., a mean flow pore size of greater than or equal to about 10 microns and less than or equal to about 50 microns). Other values and ranges of mean flow pore size are also possible

Mullen burst tests may be used as a test for strength in measuring the pressure required for puncturing the fiber web as an indicator of the load carrying capacity of the fiber web under certain conditions. Mullen burst strength is measured according to the Standard TAPPI T403. In some embodiments, the fiber web may have a dry Mullen Burst strength of greater than or equal to about 5 psi, greater than or equal to about 10 psi, greater than or equal to about 15 psi, greater than or equal to about 20 psi, greater than or equal to about 25 psi, greater than or equal to about 30 psi, greater than or equal to about 35 psi, greater than or equal to about 40 psi, greater than or equal to about 45 psi, greater than or equal to about 50 psi, or greater than or equal to about 55 psi. In some instances, the dry Mullen Burst strength may be less than or equal to about 60 psi, less than or equal to about 55 psi, less than or equal to about 50 psi, less than or equal to about 45 psi, less than or equal to about 40 psi, less than or equal to about 35 psi, less than or equal to about 30 psi, less than or equal to about 25 psi, less than or equal to about 20 psi, or less than or equal to about 15 psi. Combinations of the above-referenced ranges are also possible (e.g., greater than or equal to about 25 psi and less than or equal to about 60 psi). Other values of dry Mullen Burst strength are also possible. The dry Mullen Burst strength may be determined according to the standard T403 om-91.

In some embodiments, a fiber web described herein has a relatively high strength even after being subjected to a hot hydraulic fluid or lubricating oil (e.g., synthetic oil) for a prolonged period of time. The increased strength of the fiber web may be attributed, at least in part, by the inclusion of an acid scavenger in the fiber web. In certain embodiments, a fiber web includes one or more of the above-noted ranges, or a combination of the above-noted ranges, for Mullen burst strength after the fiber web has been subjected to a sealed vessel, no exclusion of air, hot oil test at a temperature of at least 150° C. for at least 168 hours. In general, the hot oil test may be performed as follows. An Ofite 316 stainless steel old-style aging cell with a 500 mL capacity vessel is charged with 400 mL of Mobil 1, 5W-30 weight, advanced full synthetic oil. The vessel is sealed, such that air is not able to enter or exit the vessel. At least 4 fiber web samples with a dimension of 2″×3½″ are added to the vessel. The vessel is sealed and placed in an oven held that is held at 150° C. for at least 168 hours. The vessel is removed from the oven and allowed to cool down to room temperature prior to opening. Samples are removed from the vessel, excess oil is blotted off, and the samples are immersed in heptane to remove oil residue from the surface. Samples are then allowed to condition for at least 12 hours at 22° C. at a relative humidity of 31-35% prior to Mullen burst strength testing.

The fiber web described herein may also exhibit advantageous filtration performance characteristics, such as dust holding capacity (DHC), efficiency, air permeability, amongst others.

The fiber webs described herein can have beneficial dust holding properties. In some embodiments, the fiber web may have a DHC of between about 80 g/m² and about 500 g/m². In some embodiments, the DHC may be greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², greater than or equal to about 300 g/m², greater than or equal to about 350 g/m², greater than or equal to about 400 g/m², greater than or equal to about 450 g/m². In some cases, the DHC may be less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 225 g/m², less than or equal to about 200 g/m², less than or equal to about 175 g/m², less than or equal to about 150 g/m², less than or equal to about 125 g/m², or less than or equal to about 100 g/m². Combinations of the above-referenced ranges are also possible (e.g., a DHC of greater than about 150 g/m² and less than or equal to about 300 g/m²). Other ranges are also possible.

The dust holding capacity, as referred to herein, is tested based on a Multipass Filter Test following the ISO 16889/19438 procedure (modified by testing a flat sheet sample) on a Multipass Filter Test Stand manufactured by FTI. The test may be run under different conditions. The testing uses ISO A3 Medium test dust manufactured by PTI, Inc. at a base upstream gravimetric dust level (BUGL) of 10 to 50 mg/liter. The test fluid is Aviation Hydraulic Fluid AERO HFA MIL H-5606A manufactured by Mobil. The test is run at a face velocity of 0.06 to 0.16 cm/s until a terminal pressure of 1 to 2 bar (100 to 200 kPa). Unless otherwise stated, the dust holding capacity values (and/or efficiency values) described herein are determined at a BUGL of 25 mg/L, a face velocity of 0.06 cm/s, and a terminal pressure of 100 kPa.

The efficiency (e.g., liquid filtration efficiency) of filtering various particle sizes can be measured using the Multipass Filter Test described above. Suitable fiber webs may be used for the filtration of particles having a size, for example, of greater than or equal to about 50 microns, greater than or equal to about 30 microns, greater than or equal to about 20 microns, greater than or equal to about 15 microns, greater than or equal to about 10 microns, greater than or equal to about 5 microns, greater than or equal to about 4 microns, greater than or equal to about 3 microns, or greater than or equal to about 1 micron. Particle counts (particles per milliliter) at the minimum particle sizes selected (e.g., 4, 5, 7, 10, 15, 20, 25, 30, 40 or 50 microns) upstream and downstream of the media can be taken at ten points equally divided over the time of the test. The average of upstream and downstream particle counts can be taken at each selected minimum particle size and particles greater than that size. From the average particle count upstream (injected, C₀) and the average particle count downstream (passed thru, C) the liquid filtration efficiency test value for each minimum particle size selected can be determined by the relationship [(1−[C/C₀])*100%].

The fiber webs described herein may have a wide range of efficiencies (e.g., liquid filtration efficiencies). In some embodiments, a fiber web has an efficiency of between about 2% and about 100% (e.g., between about 20% and about 100%). The efficiency may be, for example, greater than or equal to about 2%, greater than or equal to about 5%, greater than or equal to about 10%, greater than or equal to about 20%, greater than or equal to about 35%, greater than or equal to about 50%, greater than or equal to about 65%, greater than or equal to about 80%, greater than or equal to about 90%, greater than or equal to about 95%, greater than or equal to about 97%, or greater than or equal to about 99%. Such efficiencies may be achieved for filtering particles of different sizes such as particles of 10 microns or greater, particles of 8 microns or greater, particles of 6 microns or greater, particles of 5 microns or greater, particles of 4 microns or greater, particles of 3 microns or greater, particles of 2 microns or greater, or particles of 1 micron or greater. Other particle sizes and efficiencies are also possible.

The fiber webs may exhibit suitable air permeability characteristics. In some embodiments, the air permeability may range from between about 0.5 cubic feet per minute per square foot (cfm/sf) and about 250 cfm/sf (e.g., between about 0.5 cfm/sf and about 50 cfm/sf, between about 50 cfm/sf and about 125 cfm/sf, between about 5 cfm/sf and about 150 cfm/sf, between about 10 cfm/sf and about 150 cfm/sf, or between about 50 cfm/sf and about 150 cfm/sf). In some embodiments, the air permeability may be greater than or equal to about 0.5 cfm/sf, greater than or equal to about 2 cfm/sf, greater than or equal to about 5 cfm/sf, greater than or equal to about 10 cfm/sf, greater than or equal to about 25 cfm/sf, greater than or equal to about 50 cfm/sf, greater than or equal to about 75 cfm/sf, greater than or equal to about 100 cfm/sf, greater than or equal to about 150 cfm/sf, greater than or equal to about 200 cfm/sf, or greater than or equal to about 250 cfm/sf. In certain embodiments, the air permeability may be less than or equal to about 300 cfm/sf, less than or equal to about 250 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, less than or equal to about 50 cfm/sf, less than or equal to about 25 cfm/sf, or less than or equal to about 5 cfm/sf. Combinations of the above-referenced ranges are also possible (e.g., an air permeability of greater than or equal to 5 cfm/sf and less than or equal to about 200 cfm/sf). Other ranges are also possible.

In some embodiments, a fiber web described herein has good air permeability even after being subjected to hot oil (e.g., a lubricating fluid) for a prolonged period of time. The improvement, relative to conventional fiber webs, of air permeability of the fiber web after prolonged filtration may be attributed, at least in part, by the inclusion of an acid scavenger in the fiber web. In certain embodiments, a fiber web includes one or more of the above-noted ranges, or a combination of the above-noted ranges, for air permeability after the fiber web has been subjected to a hydraulic fluid or lubricating oil (e.g., synthetic oil) at a temperature of at least 150° C. for at least 168 hours, according to the hot oil test described above.

As determined herein, the permeability is measured according to the Standard TAPPI T-251. The permeability is an inverse function of flow resistance and can be measured with a Frazier Permeability Tester (e.g., TexTest Instrument, FX 3300). The Frazier Permeability Tester measures the volume of air per unit of time that passes through a unit area of sample at a fixed differential pressure across the sample. Permeability can be expressed in cubic feet per minute per square foot at a 0.5 inch water pressure differential.

It should be appreciated that although the parameters and characteristics noted above are described with respect to fiber webs, the same parameters and characteristics (including the values and ranges for such parameters and characteristics) may also be applied to filter media.

Fiber webs described herein may be used in an overall filtration arrangement or filter element. In some embodiments, one or more additional layers or components are included with the fiber web (e.g., disposed adjacent to the fiber web, contacting one or both sides of the fiber web). Non-limiting examples of additional layers include a meltblown layer, a wet laid layer, a spunbond layer, or an electrospun layer. In some embodiments, multiple fiber webs in accordance with embodiments described herein may be layered together in forming a multi-layer sheet for use in a filter media or element.

As described herein, in some embodiments two or more layers of a web may be formed separately, and combined by any suitable method such as lamination, collation, or by use of adhesives. The two or more layers may be formed using different processes, or the same process. For example, each of the layers may be independently formed by a wet laid process, a non-wet laid process, or any other suitable process.

In some embodiments, two or more layers may be formed by the same process. In some instances, the two or more layers may be formed simultaneously. In some embodiments, a gradient in at least one property may be present across the thickness of the two or more layers.

Different layers may be adhered together by any suitable method. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

A fiber web or filter media may include any suitable number of layers, e.g., at least 2, at least 3, at least 4, at least 5, at least 6, at least 7 layers. In some embodiments, a fiber web or filter media may include up to 20 layers.

In certain embodiments, a fiber web may include a gradient in one or more properties (e.g., mean flow pore size) through portions of the thickness of the fiber web. In the portions of the fiber web where the gradient in the property is not present, the property may be substantially constant through that portion of the web. As described herein, in some instances a gradient in a property involves different proportions of a component (e.g., a type of fiber such as a fibrillated fiber, hardwood fibers, softwood fibers, an additive, a binder) across the thickness of a fiber web. In some embodiments, a component may be present at an amount or a concentration that is different than another portion of the fiber web. In other embodiments, a component is present in one portion of the fiber web, but is absent in another portion of the fiber web. Other configurations are also possible.

In some embodiments, a fiber web has a gradient in one or more properties in two or more regions of the fiber web. For example, a fiber web including three layers may have a first gradient in one property across the first and second layer, and a second gradient in another property across the second and third layers. The first and second gradients may be the same in some embodiments, or different in other embodiments (e.g., characterized by a gradual vs. an abrupt change in a property across the thickness of the fiber web). Other configurations are also possible.

Fiber webs described herein may be produced using suitable processes, such as using a wet laid or a dry laid process. In general, a wet laid process involves mixing together of fibers of one or more type; for example, cellulose fibers of one type may be mixed together with cellulose fibers of another type, and/or with fibers of a different type (e.g., synthetic fibers and/or glass fibers), to provide a fiber slurry. The slurry may be, for example, an aqueous-based slurry. In certain embodiments, fibers, are optionally stored separately, or in combination, in various holding tanks prior to being mixed together.

For instance, a first fiber may be mixed and pulped together in one container and a second fiber may be mixed and pulped in a separate container. The first fibers and the second fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In certain embodiments, two or more layers are formed by a wet laid process. For example, a first dispersion (e.g., a pulp) containing fibers in a solvent (e.g., an aqueous solvent such as water) can be applied onto a wire conveyor in a papermaking machine (e.g., a fourdrinier or a rotoformer) to form first layer supported by the wire conveyor. A second dispersion (e.g., another pulp) containing fibers in a solvent (e.g., an aqueous solvent such as water) is applied onto the first layer either at the same time or subsequent to deposition of the first layer on the wire. Vacuum is continuously applied to the first and second dispersions of fibers during the above process to remove the solvent from the fibers, thereby resulting in an article containing first and second layers. The article thus formed is then dried and, if necessary, further processed (e.g., calendered) by using known methods to form multi-layered fiber webs. In some embodiments, such a process may result in a gradient in at least one property across the thickness of the two or more layers.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. A fiber web can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

Wet laid processes may be particularly suitable for forming gradients of one or more properties in a fiber web, such as those described herein. For instance, in some cases, the same slurry is pumped into separate headboxes to form different layers and/or a gradient in a fiber web. In other cases, two or more different slurries may be pumped into separate headboxes to form different layers and/or a gradient in a fiber web. For laboratory samples, a first layer can be formed from a fiber slurry, drained and dried and then a second layer can be formed on top from a fiber slurry. In other embodiments, a first layer can be formed and a second layer can be formed on top, drained, and dried.

In some cases, the pH of the fiber slurry may be adjusted as desired. For instance, fibers of the slurry may be dispersed under generally neutral conditions.

Before the slurry is sent to a headbox, the slurry may optionally be passed through centrifugal cleaners and/or pressure screens for removing unfiberized material. The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, a cylinder, or an inclined wire fourdrinier.

As described herein, in some embodiments, a resin, which may optionally contain an acid scavenger, is added to a pre-formed fiber layer (e.g., a pre-formed fiber web formed by a wet-laid process). For instance, as the fiber layer is passed along an appropriate screen or wire, different components included in the resin (e.g., polymeric binder, an acid scavenger, and/or other components), which may be in the form of separate emulsions, are added to the fiber layer using a suitable technique. In some cases, each component of the resin is mixed as an emulsion prior to being combined with the other components and/or fiber layer. The components included in the resin may be pulled through the fiber layer using, for example, gravity and/or vacuum. In some embodiments, one or more of the components included in the resin may be diluted with softened water and pumped into the fiber layer. In some embodiments, a resin may be applied to a fiber slurry prior to introducing the slurry into a headbox. For example, the resin may be introduced (e.g., injected) into the fiber slurry and impregnated with and/or precipitated on to the fibers. In some embodiments, a resin may be added to a fiber web by a solvent saturation process.

In other embodiments, a dry laid process is used to form all or portions of a fiber web. In a dry laid process, an air laid process or a carding process may be used. For example, in an air laid process, synthetic fibers may be mixed along with cellulose fibers, while air is blown onto a conveyor, and a resin is then applied. In a carding process, in some embodiments, the fibers are manipulated by rollers and extensions (e.g., hooks, needles) associated with the rollers prior to application of the binder. In some cases, forming the fiber webs through a dry laid process may be more suitable for the production of a highly porous media. The dry fiber web may be impregnated (e.g., via saturation, spraying, etc.) with any suitable resin, as discussed above.

During or after formation of a fiber web, the fiber web may be further processed according to a variety of known techniques. For instance, a coating method described herein may be used to include a resin (e.g., a resin containing an acid scavenger) in the fiber web. Optionally, additional layers can be formed and/or added to a fiber web using processes such as lamination, co-pleating, or collation. For example, in some cases, two layers are formed into a composite article by a wet laid process as described above, and the composite article is then combined with a third layer by any suitable process (e.g., lamination, co-pleating, or collation). It can be appreciated that a fiber web or a composite article formed by the processes described herein may be suitably tailored not only based on the components of each fiber layer, but also according to the effect of using multiple fiber layers of varying properties in appropriate combination to form fiber webs having the characteristics described herein.

In some embodiments, further processing may involve pleating the fiber web. For instance, two layers may be joined by a co-pleating process. In some cases, the fiber web, or various layers thereof, may be suitably pleated by forming score lines at appropriately spaced distances apart from one another, allowing the fiber web to be folded. It should be appreciated that any suitable pleating technique may be used.

In some embodiments, a fiber web can be post-processed such as subjected to a corrugation process to increase surface area within the web. In other embodiments, a fiber web may be embossed.

It should be appreciated that the fiber web may include other parts in addition to the one or more layers described herein. In some embodiments, further processing includes incorporation of one or more structural features and/or stiffening elements. For instance, the fiber web may be combined with additional structural features such as polymeric and/or metallic meshes. In one embodiment, a screen backing may be disposed on the fiber web, providing for further stiffness. In some cases, a screen backing may aid in retaining the pleated configuration. For example, a screen backing may be an expanded metal wire or an extruded plastic mesh.

In some embodiments, fiber webs used as filter media can be incorporated into a variety of filter elements for use in various filtering applications. Exemplary types of filters include oil filters (e.g., lube oil filters or heavy duty lube oil filters) and hydraulic mobile filters, hydraulic industrial filters, fuel filters (e.g., automotive fuel filters).

The fiber webs and filter media disclosed herein can be incorporated into a variety of filter elements for use in various applications including lube and non-lube filtration applications including hydraulic applications, amongst others. Exemplary uses of lube filters (e.g., high-, medium-, and low-pressure filters) include mobile and industrial filters.

During use, the fiber webs mechanically trap particles on or in the layers as fluid flows through the filter media. The fiber webs need not be electrically charged to enhance trapping of contamination. Thus, in some embodiments, the filter media are not electrically charged. However, in some embodiments, the filter media may be electrically charged.

### Examples

The following examples are intended to illustrate certain embodiments of the present invention, but are not to be construed as limiting and do not exemplify the full scope of the invention.

Fiber webs coated with a resin containing an acid scavenger, an antioxidant, and/or binder fibers were formed.

Fiber webs (lab-prepared handsheets) were formed from cellulose fibers by a wet-laid process. Binder fibers, if present, were added to the fiber web during the wet-laid process and constituted less than or equal to about 0.05 wt. % of the total fibers in the fiber web. The coated fiber webs had a basis weight of about 178 g/m². A resin coating was formed by adding phenolic resin to methanol. The acid scavenger and/or antioxidant were then added to the resin solution. The solution was thoroughly mixed with an air driven paddle stirrer. When the acid scavenger and/or antioxidant were present in the resin solution, the solution contained about 7 wt % acid scavenger and/or 0.1 wt. % antioxidant based on the dry solids.

The fiber webs were dried and weighed prior to use. Impregnation of sheets with the resin solution was carried out using a lab size press applicator roll. Impregnated sheets were allowed to air dry and then weighed. Resin pickup was calculated by subtracting the base weight from the impregnation weight and then dividing by the impregnation weight. The impregnated sheets were cured at 150° C. for 10 min. Sheets were cut into 2″×3½″ strips for hot oil testing. Table 1 shows the weight percentage of acid scavenger, an antioxidant, and/or binder fibers in the fiber webs and the Mullen burst strength after the hot oil test in each of the fiber webs.

TABLE 1
Mullen burst strength for fiber webs containing various weight
percentages of an acid scavenger, an antioxidant, and/or
binder fibers after the hot oil test.

| | Binder | | | Normalized 168 hr |
|---|---|---|---|---|
| Web | Fibers | Acid Scavenger | Antioxidant | Mullen Burst (psi) |
| 1 | 0 | 0.075 | 0 | 25.8 |
| 2 | 0.025 | 0 | 0 | 16.7 |
| 3 | 0 | 0 | 0.005 | 13.1 |
| 4 | 0.05 | 0 | 0.005 | 13.1 |
| 5 | 0.025 | 0.075 | 0.005 | 39.0 |

The coated fiber webs were subjected to a sealed vessel, no exclusion of air, hot oil test. The hot oil test was performed as follows. An Ofite 316 stainless steel old-style aging cell with a 500 mL capacity vessel was charged with 400 mL of Mobil 1, 5W-30 weight, advanced full synthetic oil. The vessel was sealed and air was not able to enter or exit the vessel. To this vessel were added 4-6 test samples of a coated fiber web. The vessel was sealed and placed in an oven held at 150° C. for 168 hours. The vessel was removed from the oven and allowed to cool down to room temperature prior to opening. Samples were removed from the vessel, excess oil was blotted off, and the samples were immersed in heptane to remove oil residue from the surface. Samples were allowed to condition for at least 12 hours at 22° C. at a relative humidity of 31-35%. Samples were tested using a Mullen burst strength tester.

After the hot oil test, only fiber webs containing an acid scavenger had a dry Mullen burst strength of greater than 17 psi. The fiber web 1 containing only the acid scavenger had a dry Mullen burst strength of about 25.8 psi. The fiber web 5 containing acid scavenger, binder fiber, and an antioxidant had a dry Mullen Burst strength of about 39 psi, which was about 163% and about 46.9% greater than the dry Mullen Burst strength of fiber web 4, which contained a binder fiber and an antioxidant, and fiber web 1, which contained only an acid scavenger, respectively. It should be understood that fiber webs comprising non-binder fiber synthetic fibers could have been used in the Example. These fiber webs containing an acid scavenger, an antioxidant, and/or binder fibers would be expected to have a higher Mullen burst strength than the cellulose fiber webs used in the Example.

What is claimed is:

1. A fiber web, comprising:
a plurality of cellulose fibers having an average fiber diameter between about 2 microns and about 75 microns and an average length between about 1 mm and about 15 mm;
a resin comprising a non-particulate acid scavenger; and
0-30 wt. % synthetic fibers.

2. A fiber web, comprising:
a plurality of cellulose fibers having an average fiber diameter between about 2 microns and about 75 microns and an average length between about 1 mm and about 15 mm;
0-30 wt. % synthetic fibers; and
an acid scavenger,
wherein the fiber web has a dry Mullen burst strength of greater than or equal to about 12 psi after being immersed in 150° C. synthetic oil for at least 168 hours.

3. A method of filtering a liquid, comprising:
passing a liquid across a fiber web, wherein the fiber web comprises:
a plurality of cellulose fibers having an average fiber diameter between about 2 microns and about 75 microns and an average length between about 1 mm and about 15 mm;
a resin comprising a non-particulate acid scavenger; and
0-30 wt. % synthetic fibers.

4. (canceled)

5. A fiber web as in claim 1, wherein the acid scavenger comprises a nitrogen.

6. A fiber web as in claim 1, wherein the acid scavenger comprises an amine.

7. A fiber web as in claim 1, wherein the acid scavenger is immobilized on the fiber web.

8. A fiber web as in claim 2, wherein the acid scavenger is a non-particulate acid scavenger.

9. A fiber web as in claim 1, wherein the solubility of the acid scavenger in water is greater than or equal to about 0.01 g/mL.

10. A fiber web as in claim 1, wherein the acid scavenger is an organic molecule.

11. A fiber web as in claim 1, wherein the fiber web comprises greater than or equal to about 0.01 wt % and less than about 0.1 wt % acid scavenger.

12. A fiber web as in claim 1, wherein the fiber web comprises greater than or equal to about 40 wt. % of cellulose fibers.

13. A fiber web as in claim 1, wherein the fiber web has a dry Mullen burst strength of greater than or equal to about 12 psi after being immersed in 150° C. synthetic oil for at least 168 hours.

14. A fiber web as in claim 1, wherein the air permeability of the fiber web is between about 2 CFM and about 100 CFM.

15. A fiber web as in claim 1, wherein the dust holding capacity of the fiber web is between about 80 g/m² and about 500 g/m².

16-17. (canceled)

18. A filter element comprising the fiber web of claim 1.

19. A filter element comprising the fiber web of claim 2.

20. A fiber web as in claim 1, wherein the fiber web has a dry Mullen burst strength of greater than or equal to about 20 psi after being immersed in 150° C. synthetic oil for at least 68 hours.

21. A fiber web as in claim 1, wherein the fiber web comprises a residue of a binder fiber.

22. A fiber web as in claim 1, wherein the fiber web comprises an antioxidant.
